(19) United States
(12) Patent Application Publication
(10) Pub. No.: US 2021/0366412 A1
(43) Pub. Date: Nov. 25, 2021

(54) DISPLAY SYSTEM WITH A BACKLIGHT

(71) Applicant: Himax Technologies Limited, Tainan City (TW)

(72) Inventors: Chih-Ying Lin, Tainan City (TW); Ming-Hong Lu, Tainan City (TW)

(21) Appl. No.: 16/880,808

(22) Filed: May 21, 2020

(51) Int. Cl. G09G 3/34; G09G 3/36

(52) U.S. Cl. CPC G09G 3/3406; G09G 3/36; G09G 2320/064; G09G 2320/0247; G09G 2310/08

(57) ABSTRACT

A display system with a backlight includes a panel composed of a plurality of pixels; a backlight driver that controls illumination of the backlight by a pulse-width modulation (PWM) control signal; and a timing controller that synchronizes with the backlight driver by a synchronization control signal. A portion of the PWM control signal within a period of the synchronization control signal is adjusted when a frame rate deviates from a predetermined rate, the frame rate representing a frequency at which images are displayed on the panel.

### BACKGROUND OF THE INVENTION

### 1. Field of the Invention

The present invention generally relates to a display system, and more particularly to a display system with a local-dimming backlight.

### 2. Description of Related Art

As liquid crystal displays (LCDs) do not produce light themselves, a backlight is required to provide illumination to the LCDs. The light source of the backlight may be composed of light-emitting diodes (LEDs).

In order to improve the contrast, a backlight dimming technique is adopted to dynamically control luminance of the backlight. Global dimming is one type of backlight dimming, in which luminance of entire display panel is controlled at the same time. The global dimming can substantially improve dynamic contrast between two consecutive frames. Local dimming is another type of backlight dimming, in which luminance of partial display panel within one frame is controlled. The local dimming can substantially improve static contrast.

Conventional dimming methods, particularly local dimming methods, suffer flickers when frame rate changes. A need has arisen to propose a novel scheme to overcome disadvantages of conventional local dimming methods.

### SUMMARY OF THE INVENTION

In view of the foregoing, it is an object of the embodiment of the present invention to provide a display system capable of preventing flickers when a frame rate changes.

According to one embodiment, a display system with a backlight includes a panel, a backlight driver and a timing controller. The panel is composed of a plurality of pixels. The backlight driver controls illumination of the backlight by a pulse-width modulation (PWM) control signal. The timing controller synchronizes with the backlight driver by a synchronization control signal. A portion of the PWM control signal within a period of the synchronization control signal is adjusted when a frame rate deviates from a predetermined rate, the frame rate representing a frequency at which images are displayed on the panel.

According to another embodiment, at least two different channels of the backlight are synchronized at different times within a period of the synchronization control signal when a frame rate deviates from the predetermined rate.

According to a further embodiment, illumination times of at least two different channels of the backlight begin at different times within a period of the synchronization control signal when a frame rate deviates from the predetermined rate.

### BRIEF DESCRIPTION OF THE DRAWINGS

FIG. 1 shows a block diagram illustrating a display system according to one embodiment of the present invention;

FIG. 2A shows exemplary timing diagrams illustrating a synchronization control signal and a PWM control signal in a normal situation;

FIG. 2B shows exemplary timing diagrams illustrating a synchronization control signal and a PWM control signal in an abnormal situation;

FIG. 3 shows a flow diagram illustrating a method of preventing backlight flickers according to one embodiment of the present invention;

FIG. 4 shows exemplary timing diagrams illustrating a synchronization control signal and a PWM control signal in an abnormal situation according to a first exemplary embodiment of the present invention;

FIG. 5 shows exemplary timing diagrams illustrating a synchronization control signal and a PWM control signal in an abnormal situation according to a second exemplary embodiment of the present invention;

FIG. 6A shows exemplary timing diagrams illustrating a synchronization control signal and a plurality of PWM control signals in an abnormal situation according to a third exemplary embodiment of the present invention;

FIG. 6B shows exemplary timing diagrams illustrating a synchronization control signal and a plurality of PWM control signals in an abnormal situation according to the third exemplary embodiment of the present invention;

FIG. 7 shows exemplary timing diagrams illustrating a synchronization control signal and a plurality of PWM control signals in an abnormal situation according to a fourth exemplary embodiment of the present invention; and

FIG. 8 shows exemplary timing diagrams illustrating a synchronization control signal and a plurality of PWM control signals in an abnormal situation according to a fifth exemplary embodiment of the present invention.

### DETAILED DESCRIPTION OF THE INVENTION

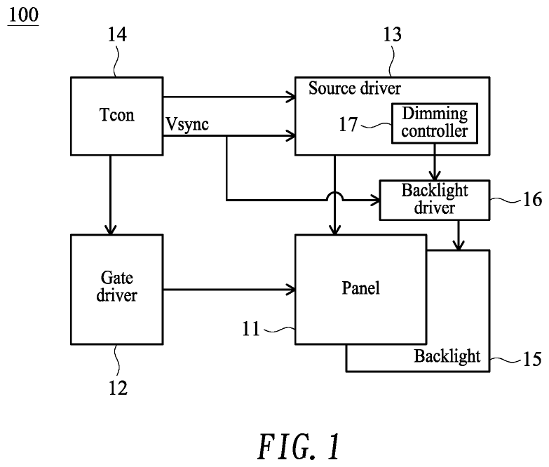

FIG. 1 shows a block diagram illustrating a display system 100 according to one embodiment of the present invention. The display system 100 (e.g., liquid crystal display or LCD) of the embodiment may primarily include a panel 11, a gate driver 12, a source driver 13 and a timing controller (Tcon) 14. Specifically, the panel 11 may include a plurality of pixels arranged in a matrix form. The gate driver 12, controlled by the timing controller 14, may scan to turn on at least one row of pixels of the panel 11 at a time, and the source driver 13, controlled by the timing controller 14, may generate image signals for corresponding columns of the turned-on row of the panel 11.

The display system 100 may further include a backlight 15 (e.g., light-emitting diode backlight or LED backlight) and a backlight driver 16. In the embodiment, the backlight 15 may be a local-dimming backlight, and be divided into channels (or blocks) that may individually illuminate the panel 11 under control of the backlight driver 16. The backlight driver 16 may control illumination of the backlight 15 by a pulse-width modulation (PWM) control signal having a duty cycle representing a ratio of illumination time to an entire period of the PWM control signal. The backlight driver 16 may be synchronized with the timing controller 14 by a synchronization control signal (e.g., vertical synchronization signal) Vsync. A frame rate representing the frequency at which images are displayed on the panel 11 may be set by the synchronization control signal Vsync such that the frame rate may be equal to the frequency of the synchronization control signal Vsync. It is noted that, in a normal situation, the frame rate is equal to a predetermined rate, and a (PWM) frequency of the PWM control signal is an integral multiple of the frame rate.

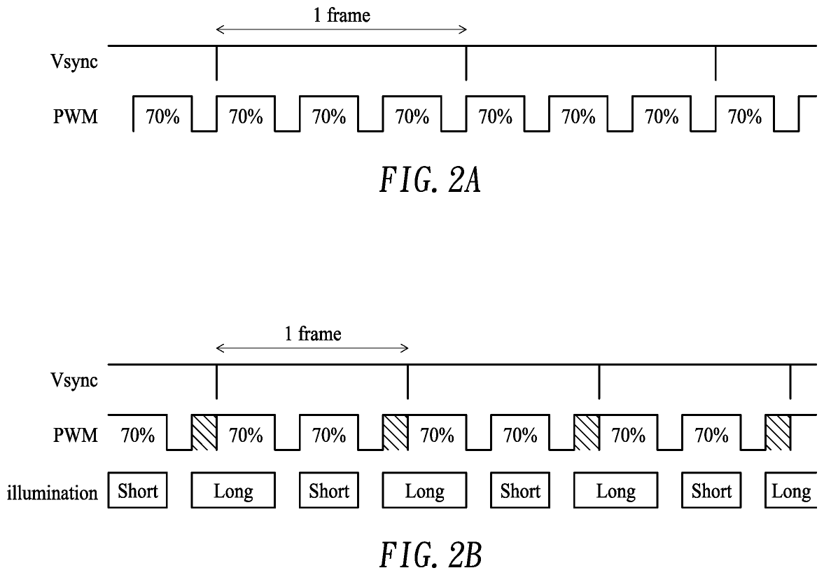

FIG. 2A shows exemplary timing diagrams illustrating a synchronization control signal Vsync and a PWM control signal (e.g., with a duty cycle of 70%) of one channel in a normal situation, in which the frame rate is equal to the predetermined rate, and the backlight driver 16 may be properly synchronized with the timing controller 14 for the reason that the PWM frequency is an integral multiple of the frame rate.

FIG. 2B shows exemplary timing diagrams illustrating a synchronization control signal Vsync and a PWM control signal (of one channel) in an abnormal situation, in which the frame rate deviates from the predetermined rate (e.g., increase in this example), and the PWM frequency is no longer an integral multiple of the frame rate even though the backlight driver 16 is still synchronized with the timing controller 14. Therefore, incomplete (or partial) illumination (designated by hatched area) may occur in each frame. Accordingly, long illumination and short illumination may equivalently take place at regular intervals, thereby resulting in flickers as perceived by the eyes.

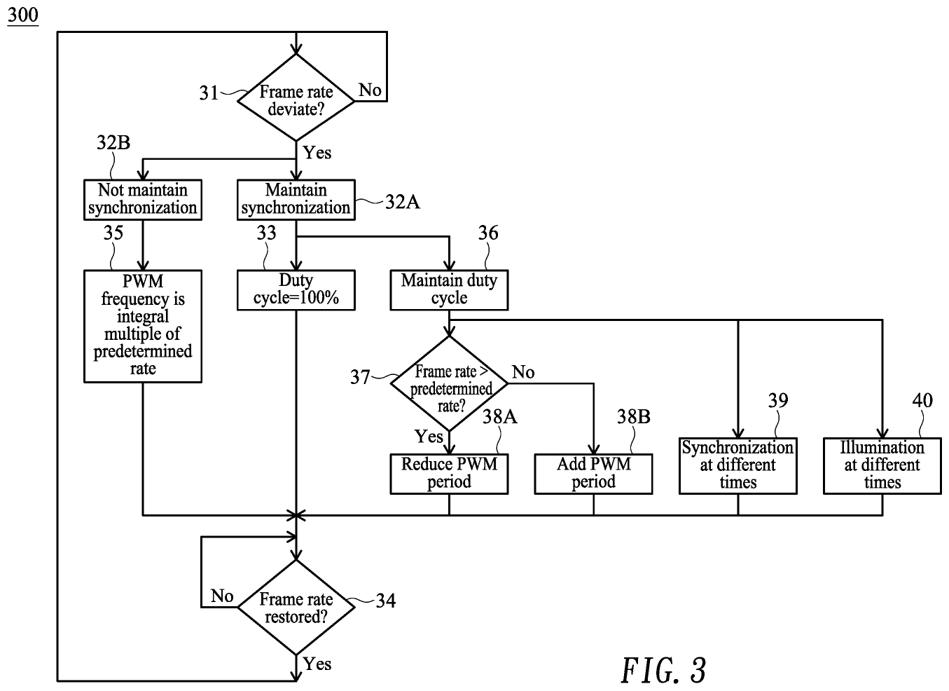

According to one aspect of the embodiment, a dimming controller 17, that controls the backlight driver 16, may be provided to prevent backlight flickers when the frame rate deviates from the predetermined rate. In one embodiment, the dimming controller 17 may, but not necessarily, be disposed in the source driver 13. FIG. 3 shows a flow diagram illustrating a method 300 of preventing backlight flickers (performed by the dimming controller 17) according to one embodiment of the present invention.

In step 31, a frame rate is compared with a predetermined rate to determine whether the frame rate deviates from the predetermined rate. If the frame rate does not deviate from the predetermined rate (e.g., a difference between the frame rate and the predetermined rate is less than a predetermined threshold), a normal (local) dimming operation is maintained, that is, the backlight driver 16 is synchronized with the timing controller 14, and the PWM frequency (of the PWM control signal) is an integral multiple of the frame rate. If the frame rate deviates from the predetermined rate in step 31, indicating that an abnormal situation occurs, the flow goes to step 32A or 32B.

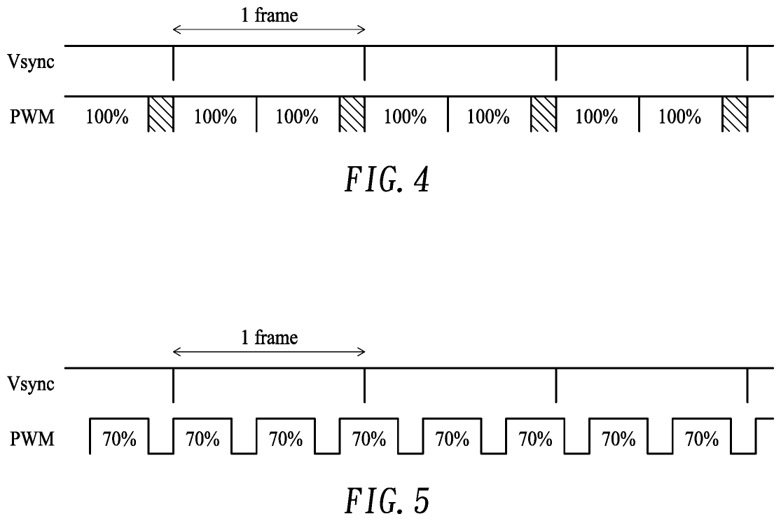

FIG. 4 shows exemplary timing diagrams illustrating a synchronization control signal Vsync and a PWM control signal (of one channel) in an abnormal situation, in which the frame rate deviates from the predetermined rate (step 31), and the PWM frequency is no longer an integral multiple of the frame rate, according to a first exemplary embodiment of the present invention.

In the embodiment, in step 32A, synchronization between the backlight driver 16 and the timing controller 14 is maintained. According to one aspect of the embodiment, in step 33, a duty cycle of the PWM control signal is set 100%, which makes the backlight 15 illuminates at all times. As the backlight 15 illuminates at all times, incomplete (or partial) illumination (designated by hatched area) occurred in each frame may not result in flickers as in FIG. 2B. Subsequently, in step 34, the dimming controller 17 may detect whether the frame rate is restored to the predetermined rate. If the result is positive, a normal (local) dimming operation is resumed and the flow goes back to step 31.

FIG. 5 shows exemplary timing diagrams illustrating a synchronization control signal Vsync and a PWM control signal (of one channel) in an abnormal situation, in which the frame rate deviates from the predetermined rate (step 31) according to a second exemplary embodiment of the present invention.

In the embodiment, in step 32B, synchronization between the backlight driver 16 and the timing controller 14 is not maintained (that is, synchronization therebetween is released). According to one aspect of the embodiment, in step 35, the PWM frequency is maintained to be an integral multiple of the predetermined rate. As the PWM frequency is no longer an integral multiple of the frame rate, no incomplete (or partial) illumination and associated flickers (as in FIG. 2B) may occur. Subsequently, in step 34, the dimming controller 17 may detect whether the frame rate is restored to the predetermined rate. If the result is positive, a normal (local) dimming operation is resumed and the flow goes back to step 31.

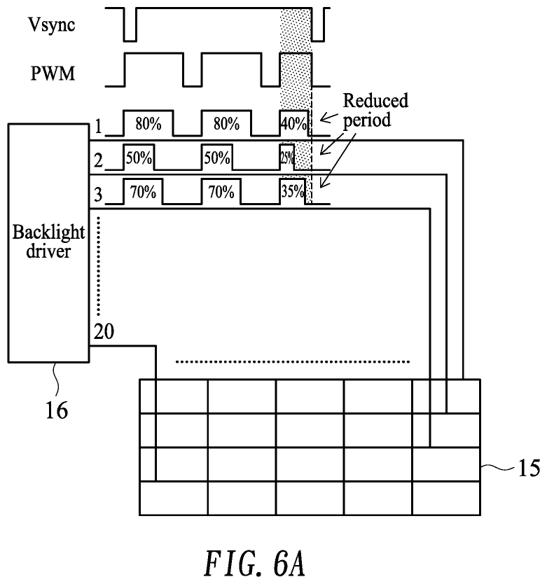

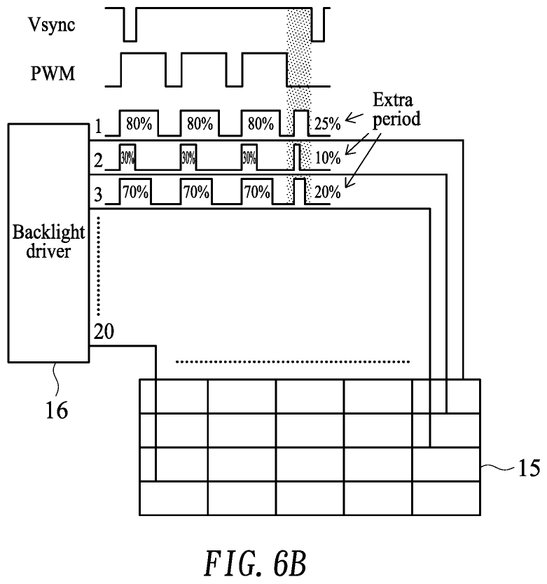

FIG. 6A shows exemplary timing diagrams illustrating a synchronization control signal Vsync and a plurality of PWM control signals (of some channels) in an abnormal situation, in which the frame rate deviates from and is greater than the predetermined rate (step 31), and the PWM frequency is no longer an integral multiple of the frame rate, according to a third exemplary embodiment of the present invention.

In the embodiment, in step 32A synchronization between the backlight driver 16 and the timing controller 14 is maintained, and in step 36, a duty cycle of each PWM control signal is maintained. In step 37, the dimming controller 17 may determine whether the frame rate is greater than the predetermined rate. If the result is positive, in step 38A, one (e.g., last) PWM period within a period of the synchronization control signal Vsync is reduced. It is noted that reduced illumination of the last PWM period should not be continuous in time with next full illumination (as defined by the duty cycle) of the backlight 15. Subsequently, in step 34, the dimming controller 17 may detect whether the frame rate is restored to the predetermined rate. If the result is positive, a normal (local) dimming operation is resumed and the flow goes back to step 31. It is appreciated that time duration of reduced illumination of the last PWM period may be fixed, random or dynamically calculated (e.g., according to contents of an image to be displayed). As no long illumination and short illumination may equivalently take place at regular intervals as in FIG. 2B, no flickers may be perceived.

FIG. 6B shows exemplary timing diagrams illustrating a synchronization control signal Vsync and a plurality of PWM control signals (of some channels) in an abnormal situation, in which the frame rate deviates from and is less than the predetermined rate (step 31), and the PWM frequency is no longer an integral multiple of the frame rate, according to the third exemplary embodiment of the present invention.

In the embodiment, in step 32A, synchronization between the backlight driver 16 and the timing controller 14 is maintained, and in step 36, a duty cycle of each PWM control signal is maintained. In step 37, the dimming controller 17 may determine whether the frame rate is greater than the predetermined rate. If the result is negative, in step 38B, an extra (or added) PWM period within a period of the synchronization control signal Vsync is added. It is noted that illumination of the added PWM period should not be continuous in time with next full illumination (as defined by the duty cycle) of the backlight 15. Subsequently, in step 34, the dimming controller 17 may detect whether the frame rate is restored to the predetermined rate. If the result is positive, a normal (local) dimming operation is resumed and the flow goes back to step 31. It is appreciated that time duration of added illumination of the added PWM period may be fixed, random or dynamically calculated (e.g., according to contents of an image to be displayed). As no long illumination and short illumination may equivalently take place at regular intervals as in FIG. 2B, no flickers may be perceived.

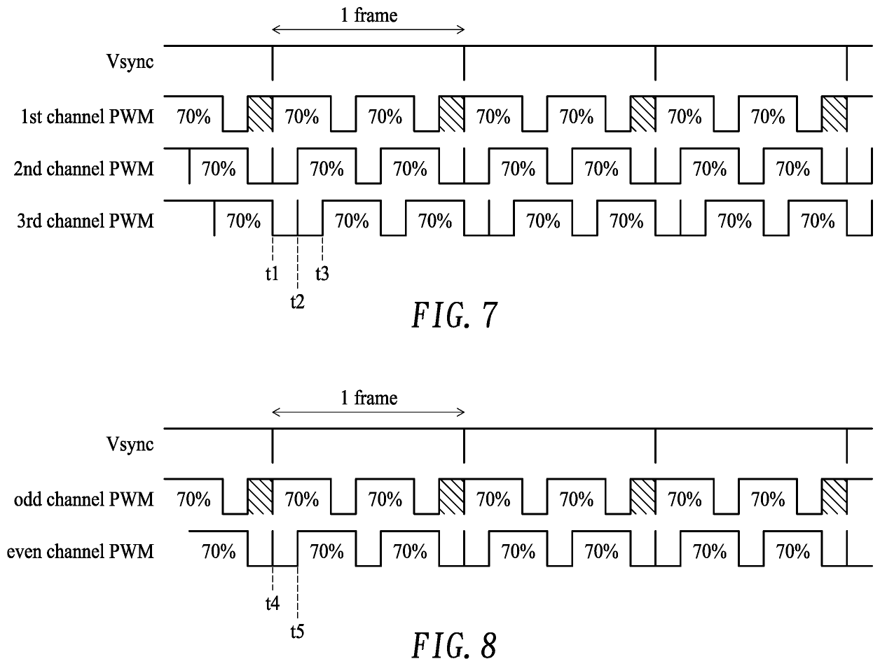

FIG. 7 shows exemplary timing diagrams illustrating a synchronization control signal Vsync and a plurality of PWM control signals (of some channels) in an abnormal situation, in which the frame rate deviates from the predetermined rate (step 31), and the PWM frequency is no longer an integral multiple of the frame rate, according to a fourth exemplary embodiment of the present invention.

In the embodiment, in step 32A, synchronization between the backlight driver 16 and the timing controller 14 is maintained, and in step 36, a duty cycle of each PWM control signal is maintained. According to one aspect of the embodiment, in step 39, at least two different channels of the backlight 15 are synchronized at different times respectively within a period of the synchronization control signal Vsync. As exemplified in FIG. 7, the first channel is synchronized at time t1, the second channel is synchronized at time t2, and the third channel is synchronized at time t3. Subsequently, in step 34, the dimming controller 17 may detect whether the frame rate is restored to the predetermined rate. If the result is positive, normal dimming is resumed and the flow goes back to step 31.

In one embodiment, synchronization time difference between different channels may be fixed, random or dynamically calculated (e.g., according to contents of an image to be displayed). As different channels are synchronized irregularly at different times respectively, no flickers may be perceived even though long illumination and short illumination may equivalently take place at regular intervals for some channels.

FIG. 8 shows exemplary timing diagrams illustrating a synchronization control signal Vsync and a plurality of PWM control signals (of some channels) in an abnormal situation, in which the frame rate deviates from the predetermined rate (step 31), and the PWM frequency is no longer an integral multiple of the frame rate, according to a fifth exemplary embodiment of the present invention.

In the embodiment, in step 32A, synchronization between the backlight driver 16 and the timing controller 14 is maintained, and in step 36, a duty cycle of each PWM control signal is maintained. According to one aspect of the embodiment, in step 40, illumination times of at least two different channels of the backlight 15 begin at different times respectively within a period of the synchronization control signal Vsync. In one embodiment, as exemplified in FIG. 8, the illumination time of odd-numbered channels begins, for example, at time t4, while the illumination time of even-numbered channels begins (e.g., at time t5) with a delayed time duration being equal to non-illumination time duration in one PWM period. It is appreciated that the delayed time duration may be fixed, random or dynamically calculated (e.g., according to contents of an image to be displayed). Subsequently, in step 34, the dimming controller 17 may detect whether the frame rate is restored to the predetermined rate. If the result is positive, normal dimming is resumed and the flow goes back to step 31. As illumination times of the PWM control signals associated with different groups begin irregularly at different times respectively, no flickers may be perceived even though long illumination and short illumination may equivalently take place at regular intervals for some channels.

Although specific embodiments have been illustrated and described, it will be appreciated by those skilled in the art that various modifications may be made without departing from the scope of the present invention, which is intended to be limited solely by the appended claims.

1. A display system with a backlight, comprising:
a panel composed of a plurality of pixels;
a backlight driver that controls illumination of the backlight by a pulse-width modulation (PWM) control signal, the backlight illuminating the panel under control of the backlight driver; and
a timing controller that synchronizes with the backlight driver by a synchronization control signal;
wherein a portion of the PWM control signal within a period of the synchronization control signal is adjusted when a frame rate deviates from a predetermined rate, the frame rate representing a frequency at which images are displayed on the panel.

2. The system of claim 1, wherein one PWM period within the period of the synchronization control signal is reduced when the frame rate is greater than the predetermined rate.

3. The system of claim 2, wherein said one PWM period is a last PWM period within the period of the synchronization control signal.

4. The system of claim 2, wherein time duration of the reduced PWM period is dynamically calculated according to contents of an image to be displayed.

5. The system of claim 1, wherein an extra PWM period within the period of the synchronization control signal is added when the frame rate is less than the predetermined rate.

6. The system of claim 5, wherein time duration of the extra PWM period is dynamically calculated according to contents of an image to be displayed.

7. The system of claim 1, further comprising:
a dimming controller that detects whether the frame rate is equal to the predetermined rate, and accordingly controls the backlight driver.

8. The system of claim 7, further comprising:
a source driver, controlled by the timing controller, that generates image signals for the panel;
wherein the dimming controller is disposed in the source driver.

9. The system of claim 1, wherein the backlight is divided into a plurality of channels that individually illuminate the panel under control of the backlight driver.

10. The system of claim 1, wherein the backlight comprises a plurality of light-emitting diodes.

11. A display system with a backlight, comprising:
a panel composed of a plurality of pixels;
a backlight driver that controls illumination of the backlight by a pulse-width modulation (PWM) control signal, the backlight being divided into a plurality of channels that individually illuminate the panel under control of the backlight driver; and
a timing controller that synchronizes with the backlight driver by a synchronization control signal;
wherein at least two different channels of the backlight are synchronized at different times within a period of the synchronization control signal when a frame rate deviates from a predetermined rate, the frame rate representing a frequency at which images are displayed on the panel.

12. The system of claim 11, wherein synchronization time difference between said two different channels is dynamically calculated according to contents of an image to be displayed.

13. The system of claim 11, further comprising:
a dimming controller that detects whether the frame rate is equal to the predetermined rate, and accordingly controls the backlight driver.

14. The system of claim 13, further comprising:
a source driver, controlled by the timing controller, that generates image signals for the panel;
wherein the dimming controller is disposed in the source driver.

15. The system of claim 11, wherein the backlight comprises a plurality of light-emitting diodes.

16. A display system with a backlight, comprising:
a panel composed of a plurality of pixels;
a backlight driver that controls illumination of the backlight by a pulse-width modulation (PWM) control signal, the backlight being divided into a plurality of channels that individually illuminate the panel under control of the backlight driver; and
a timing controller that synchronizes with the backlight driver by a synchronization control signal;
wherein illumination times of at least two different channels of the backlight begin at different times within a period of the synchronization control signal when a frame rate deviates from a predetermined rate, the frame rate representing a frequency at which images are displayed on the panel.

17. The system of claim 16, wherein illumination time difference between said two different channels is dynamically calculated according to contents of an image to be displayed.

18. The system of claim 16, further comprising:
a dimming controller that detects whether the frame rate is equal to the predetermined rate, and accordingly controls the backlight driver.

19. The system of claim 18, further comprising:
a source driver, controlled by the timing controller, that generates image signals for the panel;
wherein the dimming controller is disposed in the source driver.

20. The system of claim 16, wherein the backlight comprises a plurality of light-emitting diodes.
